(19) United States
(12) Patent Application Publication
(10) Pub. No.: US 2008/0141980 A1
(43) Pub. Date: Jun. 19, 2008

(54) Injector mounting structure of V-type internal combustion engine

(75) Inventors: Masaki Cho, Saitama (JP); Yosuke Ariga, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 11/978,721

(22) Filed: Oct. 30, 2007

(30) Foreign Application Priority Data
Dec. 13, 2006 (JP) 2006-335855

(51) Int. Cl. F02M 61/14

(52) U.S. Cl. 123/470

(57) ABSTRACT

An injector mounting structure for a V-type internal combustion engine includes an intake manifold arranged in a V-bank. A fuel supply pipe extends linearly in parallel to a crankshaft and is disposed in the V-bank. A pair of injectors are branched in an inverted V-shape in side view from the direction of the axial line of the fuel supply pipe from two branch portions P, Q apart from each other in the direction of the axial line of the fuel supply pipe and extend in parallel to each other and obliquely at an acute angle α with respect to a segment PQ connecting the two branch portions P, Q in top view. The injectors are mounted by fitting distal end portions of the pair of injectors respectively into mounting holes formed on air-intake pipes of the intake manifold on the respective sides.

### CROSS-REFERENCE TO RELATED APPLICATIONS

The present application claims priority under 35 USC 119 to Japanese Patent Application No. 2006-335855 filed on Dec. 13, 2006 the entire contents thereof is hereby incorporated by reference.

### BACKGROUND OF THE INVENTION

1. Field of the Invention

The present invention relates to an injector mounting structure with respect to an air-intake device in a V-type internal combustion engine.

2. Description of Background Art

In the related art, for example, in a V-type internal combustion engine, with the arrangement of an air intake device for sucking air in respective cylinders at a V-bank between the cylinders, an intake manifold having a structure for branching a common air-intake passage to the respective cylinders as a branched air-intake passage is achieved, so that the air-intake device may be downsized and hence the bank angle may be reduced. See, for example, Japanese Patent No. 3106724 (FIG. 1).

In the V-type internal combustion engine disclosed in Japanese Patent No. 3106724, branched pipes as the branched air-intake passages extend respectively obliquely upwardly from respective air-intake ports which communicate with combustion chambers in cylinders on the respective sides which are inclined with respect to each other in a V-shape, collected together at the center, and are connected to a surge tank.

Disposed on both sides of the center collected portion are fuel supply pipes arranged in parallel to a crankshaft, and injectors on the respective sides attached at the proximal end portions thereof to the fuel supply pipes respectively projecting downwardly and are fitted into the respective branched pipes at the distal end portions thereof.

In this manner, the injector mounting structure disclosed in Japanese Patent No. 3106724 is a structure in which the injectors on the respective sides are mounted to the fuel supply pipes on the respective sides. Thus, the number of components is large. Therefore, the assembly work takes a lot of trouble and the assembleability has a problem to solve.

### SUMMARY AND OBJECTS OF THE INVENTION

In view of such a problem, it is an object of the present invention to provide an injector mounting structure in a V-type internal combustion engine in which the number of components is small and which is superior in assembleability.

In view of the problems described above, an embodiment of the present invention provides a V-type internal combustion engine in which an intake manifold is arranged in a V-bank formed between the cylinders arranged on the respective sides so as to be inclined to form a V-shape for sucking air to the respective cylinders with an injector mounting structure of a V-type internal combustion engine. A fuel supply pipe, oriented in parallel to a crankshaft and extending linearly, is disposed in the V-bank wherein a pair of injectors are branched from two branch portions apart from each other in the direction of an axial line of the fuel supply pipe into an inverted V-shape in a side view from the direction of the axial line of the fuel supply pipe and extend in parallel to each other and obliquely at an acute angle with respect to a segment connecting the two branch portions in a top view. The injectors are mounted by fitting respective distal end portions of the pair of injectors respectively to mounting holes formed on air-intake pipes on the respective sides of the intake manifold.

In the injector mounting structure of a V-type internal combustion engine according to an embodiment of the present invention the mounting holes formed on the air-intake pipes on the respective sides are formed with water drain holes respectively.

According to an embodiment of the present invention, since the pair of injectors are branched from two branch portions apart from each other in the direction of an axial line of the fuel supply pipe into an inverted V-shape in a side view from the direction of the axial line of the fuel supply pipe, and extend in parallel to each other and obliquely at the acute angle with respect to the segment connecting the two branch portions in a top view, the injectors may be mounted by fitting the distal end portions of the respective injectors simultaneously to the respective mounting holes of the air-intake pipes on the respective sides while rotating the fuel supply pipe integrally with the pair of injectors about the center point of the segment in the direction of rotation in which the distal end portions of the injectors rotates ahead of the rear end portions thereof in top view.

Therefore, by providing the pair of the injectors so as to project from the single fuel supply pipe, the pair of injectors may be mounted simultaneously to the respective mounting holes of the air-intake pipes. Thus, the number of components is small, the assembly work is easy, and the superior assembleability is achieved.

According to an embodiment of the present invention, since the water drain holes are formed on the mounting holes formed on the air-intake pipes on the respective sides, even when the mounting holes of the air-intake pipes to which the injectors are fitted from above are formed to have a length sufficient for firmly holding the distal end portions of the injector, water drops or the like may be drained through the water drain holes so that accumulation may be avoided.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view of a V-type internal combustion engine according to an embodiment of the present invention;

FIG. 2 is a top view of the same;

FIG. 3 is a perspective view of an intake manifold;

FIG. 4 is a top view of the intake manifold;

FIG. 5 is a cross-sectional view taken along the line V-V in FIG. 4;

FIG. 6 is a top view of a fuel supply device;

FIG. 7 is a side view of the same;

FIG. 8 is a top view showing a state in which the fuel supply device is arranged at a required position above the intake manifold; and

FIG. 9 is a top view of a state in which the fuel supply device is attached to the intake manifold.

### DETAILED DESCRIPTION OF THE PREFERRED EMBODIMENTS

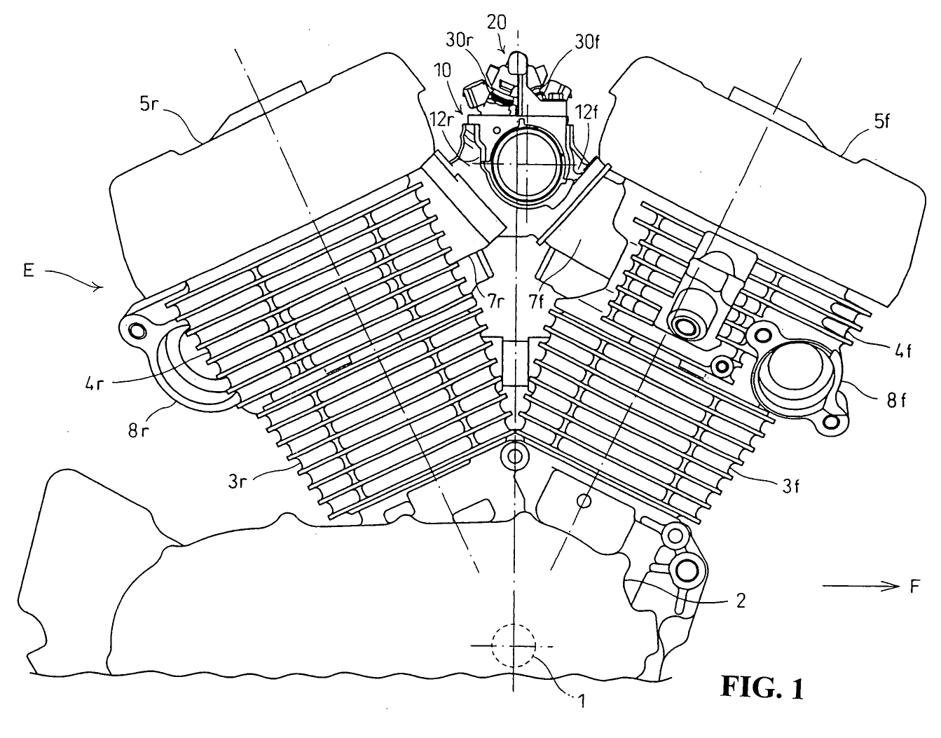

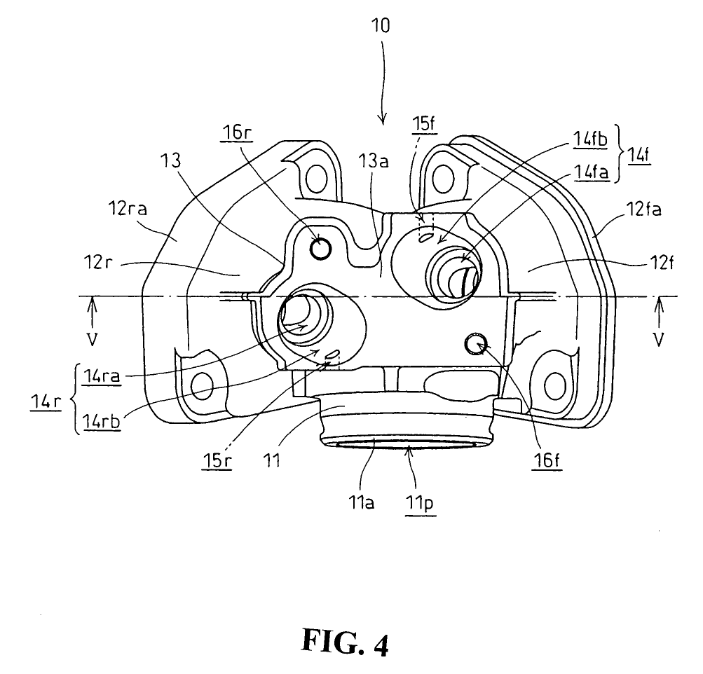

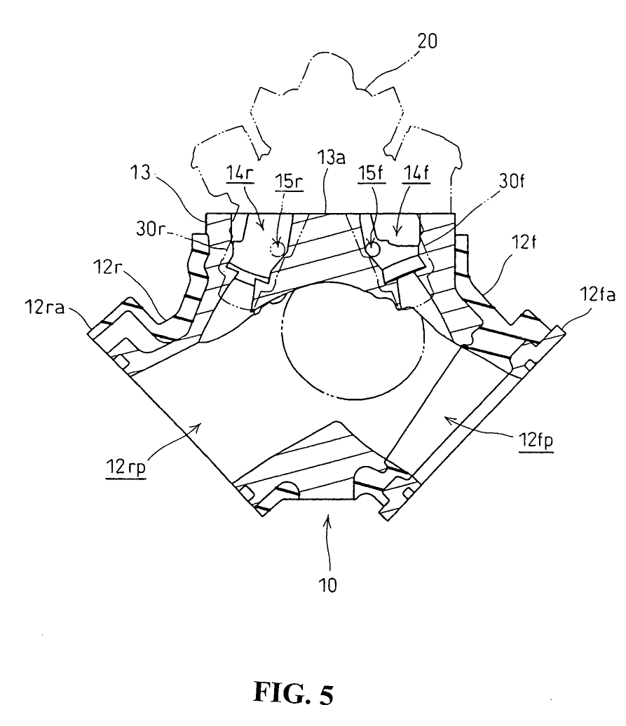

Referring now to FIG. 1 to FIG. 9, an embodiment of the present invention will be described.

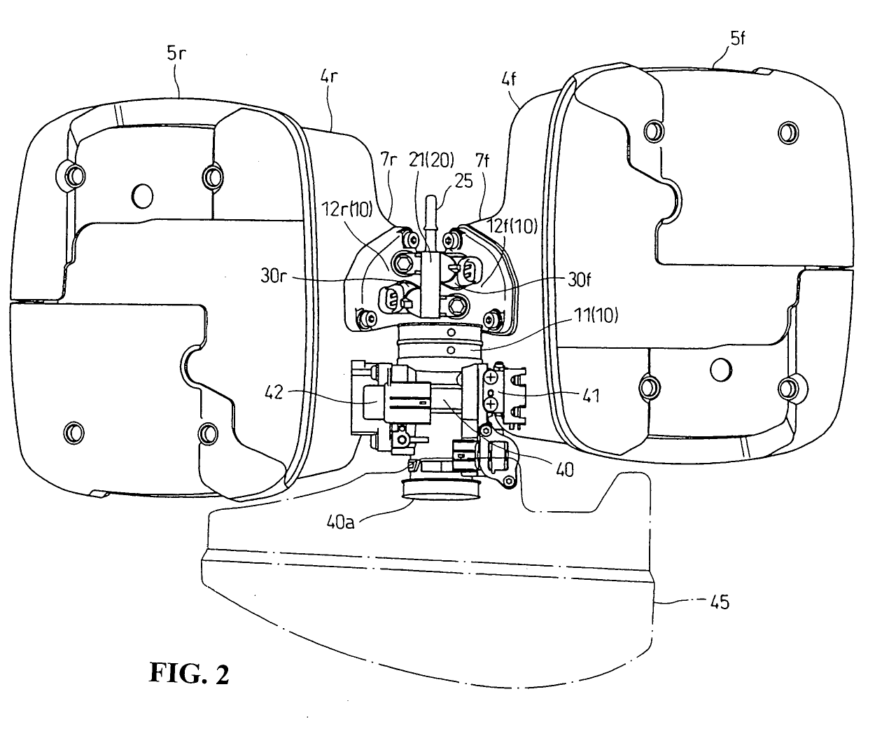

A V-type internal combustion engine E according to this embodiment is a two-cylinder water-cooled four-stroke internal combustion engine formed into a V-shape in the fore-and-aft direction, which is mounted transversely to a motorcycle with a crankshaft 1 oriented horizontally in the lateral direction. A top view of the V-type internal combustion engine E is shown in FIG. 1, and a right side view thereof is shown in FIG. 2.

In this embodiment, the front, rear, left, and right are defined based on the direction of travel of a vehicle.

The V-type internal combustion engine E includes a front bank cylinder 3f and a rear bank cylinder 3r extended obliquely upwardly from a crankcase 2, cylinder heads 4f, 4r placed on the front bank cylinder 3f and the rear bank cylinder 3r inclined in the fore-and-aft direction with cylinder head covers 5f, 5r covered respectively thereon.

A front air-intake port upstream opening end 7f of an air-intake port of the cylinder head 4f communicates with a combustion chamber of the front bank cylinder 3f projects into a V-bank. A front exhaust port downstream opening end 8f of an exhaust port which communicates with the same combustion chamber and projects obliquely rightwardly toward the front. On the other hand, a rear air-intake port upstream opening end 7r of the air-intake port of the cylinder head 4r which communicates with the combustion chamber of the rear bank cylinder 3r projects into the V-bank. A rear exhaust port downstream opening end 8r of the exhaust port which communicates with the combustion chamber projects obliquely rightwardly toward the rear.

An intake manifold 10 is connected to the front air-intake port upstream opening end 7f and the rear air-intake port upstream opening end 7r projecting into the V-bank. On the other hand, exhaust pipes, not shown, are connected respectively to the front exhaust port downstream opening end 8f and the rear exhaust port downstream opening end 8r.

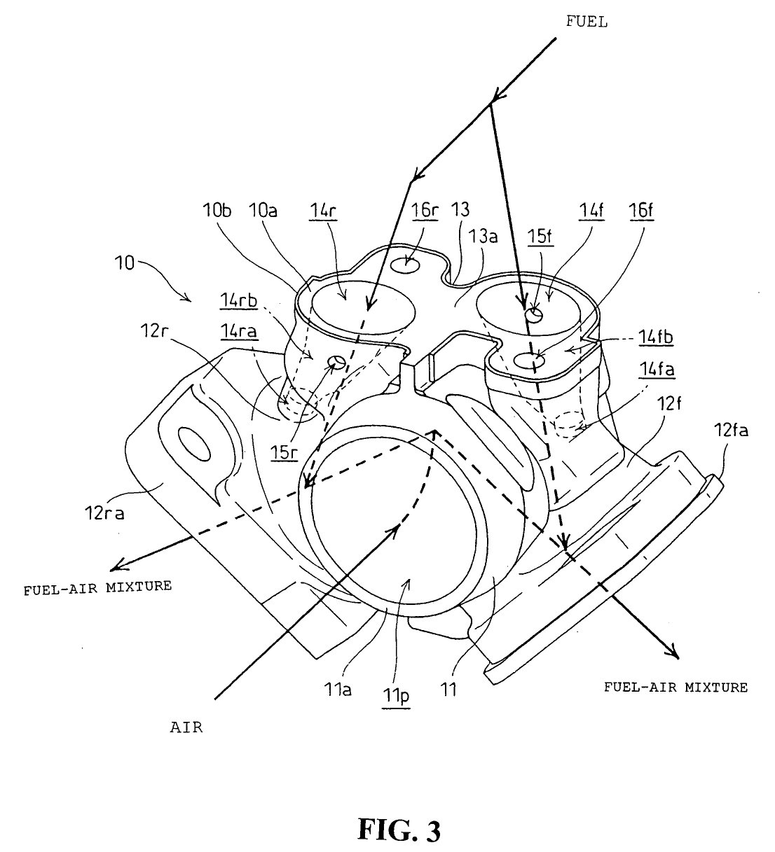

Referring now to FIG. 3 to FIG. 5, the intake manifold 10 which is disposed in the V-bank oriented in the fore-and-aft direction is branched into a front air-intake pipe 12f and a rear air-intake pipe 12r extending obliquely downwardly toward the front and rear, respectively, from a common air-intake pipe 11 arranged in parallel to the crankshaft 1 horizontally so as to be oriented in the lateral direction. Front and rear opening end flange portions 12fa, 12ra of the front air-intake pipe 12f and the rear air-intake pipe 12r are connected respectively to the front air-intake port upstream opening end 7f and the rear air-intake port upstream opening end 7r. The intake manifold 10 is bridged between the front and rear cylinder heads 4f, 4r.

In this state, the common air-intake pipe 11 is oriented so that a joint opening 11a thereof faces to the right in the horizontal direction.

The common air-intake pipe 11 oriented horizontally in the lateral direction is branched into the front air-intake pipe 12f and the rear air-intake pipe 12r toward the front and rear, and a common air-intake passage 11p formed to the left from the joint opening 11a of the common air-intake pipe 11 communicates with a front air-intake channel 12fp of the front air-intake pipe 12f and a rear air-intake channel 12rp of the rear air-intake pipe 12r. In addition, the common air-intake passage 11p is branched into the front air-intake channel 12fp and the rear air-intake channel 12rp toward the front and rear, so that intake air flows therein.

A throttle body 40 is connected to the joint opening 11a oriented horizontally toward the right of the common air-intake pipe 11 of the intake manifold 10. An air-cleaner mounting opening 40a at the right end of the throttle body 40 is connected to an air cleaner 45 arranged on the right side of the front and rear cylinder heads 4f, 4r (see FIG. 2).

A throttle valve drive unit 41 is provided on the front side of the throttle body 40. A throttle opening sensor 42 projects on the rear side thereof.

The intake manifold 10 is formed with an injector mounting base 13 so as to swell upwardly and is connect the front air-intake pipe 12f. The rear air-intake pipe 12r extends in the fore-and-after direction across the common air-intake pipe 11 oriented horizontally in the lateral direction.

A flat mounting surface 13a is formed on an upper surface of the injector mounting base 13, and a front mounting hole 14f and a rear mounting hole 14r of the injector are formed through the mounting surface 13a at front and rear positions so as to be out of alignment from each other in terms of the lateral direction.

The front mounting hole 14f is formed obliquely downwardly from the front opening on the mounting surface 13a which is shifted to the left and opens into the front air-intake channel 12fp of the front air-intake pipe 12f. The rear mounting hole 14r is formed obliquely downwardly from the rear opening on the mounting surface 13a which is shifted to the right and opens into the rear air-intake channel 12rp of the rear air-intake pipe 12r.

The front mounting hole 14f is formed with a circular fitting hole 14fa having the smallest inner diameter for fitting the injector at the lower opening end thereof which opens into the front air-intake channel 12fp and is formed with a guide hole 14fb extending gradually obliquely upwardly toward the rear from the fitting hole 14fa so as to form a distorted funnel shape, and continues to an oval-shaped opening on the mounting surface 13a.

In the same manner, the rear mounting hole 14r is formed with a circular fitting hole 14ra having the smallest inner diameter for fitting the injector at the lower opening end thereof which opens into the rear air-intake channel 12rp and is formed with a guide hole 14rb extending gradually obliquely upwardly toward the front from the fitting hole 14ra so as to form a distorted funnel shape, and continues to an oval-shaped opening on the mounting surface 13a.

Formed on the respective tapered surfaces of the guide hole 14fb of the front mounting hole 14f and the guide hole 14rb of the rear mounting hole 14r are openings of a water drain holes 15f, 15r formed from the left and right side surfaces of the injector mounting base 13.

Formed on the right side of the front mounting hole 14f and the left side of the rear mounting hole 14r are screw holes 16f, 16r respectively so as to open through the mounting surface 13a.

The intake manifold 10 is formed by coating the outer surface of a metal portion 10a with a rubber coating layer 10b, placing the metal portion 10a in a metal die, injecting melted rubber in a layer space between the metal portion and the metal die, and causing the same to be cured.

A fuel supply device 20 is mounted to the injector mounting base 13 of the intake manifold 10.

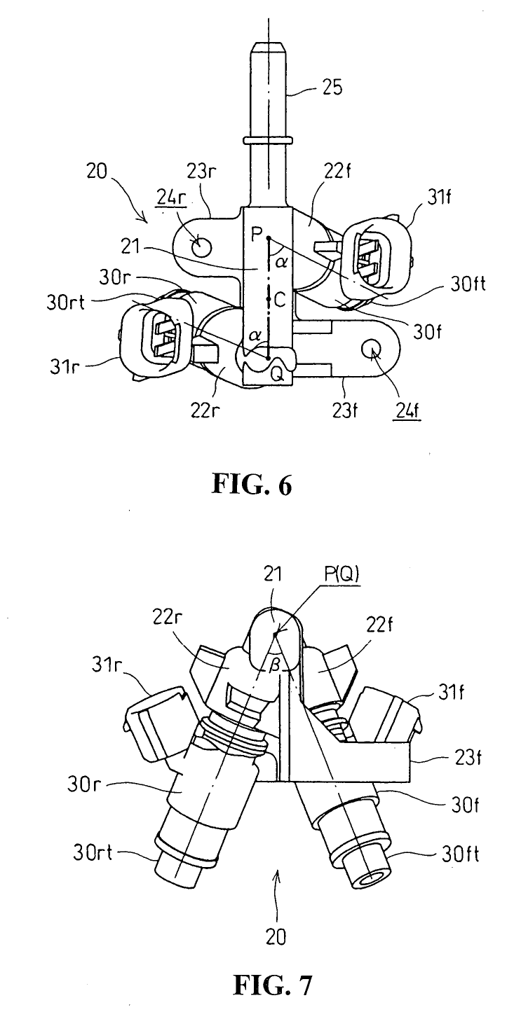

Referring now to FIGS. 6 and 7, the fuel supply device 20 is formed with a fuel supply pipe 21 at the center thereof, the fuel supply pipe 21 arranged horizontally in the lateral direction is formed with left and right injector mounting portions 22f, 22r so as to project obliquely downwardly respectively from two branched portions thereof which are apart from each other, and the proximal portions of a front injector 30f and a rear injector 30r are mounted to the respective injector mounting portions 22f, 22r.

The fuel supply pipe 21 is formed respectively with mounting brackets 23r, 23f on the opposite side from the injector mounting portions 22f, 22r so as to project therefrom, and the lower surfaces of the mounting brackets 23r, 23f are flat and come into abutment with the mounting surface 13a of the injector mounting base 13 of the intake manifold 10.

The mounting brackets 23f, 23r are formed with mounting holes 24f, 24r corresponding to screw holes 16f, 16r.

The injectors 30f, 30r include cylindrical distal end portions 30ft, 30rt with a reduced diameter, and are provided at the center portion thereof with couplers 31f, 31r for connecting power cables.

A connecting pipe 25 extends to the left from a branched portion 21L of the fuel supply pipe 21.

Referring now to FIGS. 6 and 7, assuming that the point where the center axis of the front injector 30f intersects with the center axis of the fuel supply pipe 21 is a point P, and the point where the center axis of the rear injector 30r intersects therewith is a point Q, the point P and the point Q are branch points of the front injector 30f and the rear injector 30r from the fuel supply pipe 21.

In a top view shown in FIG. 6, the front injector 30f and the rear injector 30r extend obliquely with respect to a segment PQ which connects the branch point P and the branch point Q apart from each other in the direction of the axis of the fuel supply pipe 21 at an acute angle α and in parallel to each other.

In the top view, the front injector 30f and the rear injector 30r are arranged in point symmetry with respect to a center point C of the segment PQ.

In a side view of the fuel supply pipe 21 viewed in the direction of the axial line thereof shown in FIG. 7, the front injector 30f and the rear injector 30r extend so as to branch from the fuel supply pipe 21 in an inverted V-shape. An angle β formed by the inverted V-shape is an acute angle (see FIG. 7).

In this manner, the front injector 30f and the rear injector 30r mounted to the injector mounting portions 22f, 22r of the fuel supply pipe 21 respectively and branched therefrom are attached to the front mounting hole 14f and the rear mounting hole 14r of the intake manifold 10 respectively.

In this mounting procedure, the distal end portion 30ft of the front injector 30f is fitted to the fitting hole 14fa of the front mounting hole 14f of the intake manifold 10 and the distal end portion 30rt of the rear injector 30r is fitted to the fitting hole 14ra of the rear mounting hole 14r.

In this injector mounting structure, the front injector 30f and the rear injector 30r can be mounted respectively to the front mounting hole 14f and the rear mounting hole 14r of the intake manifold 10 simultaneously in a state in which the front injector 30f and the rear injector 30r are mounted to the fuel supply pipe 21 (the state shown in FIG. 6 and FIG. 7).

A method of mounting the fuel supply device 20 to the intake manifold 10 will now be described.

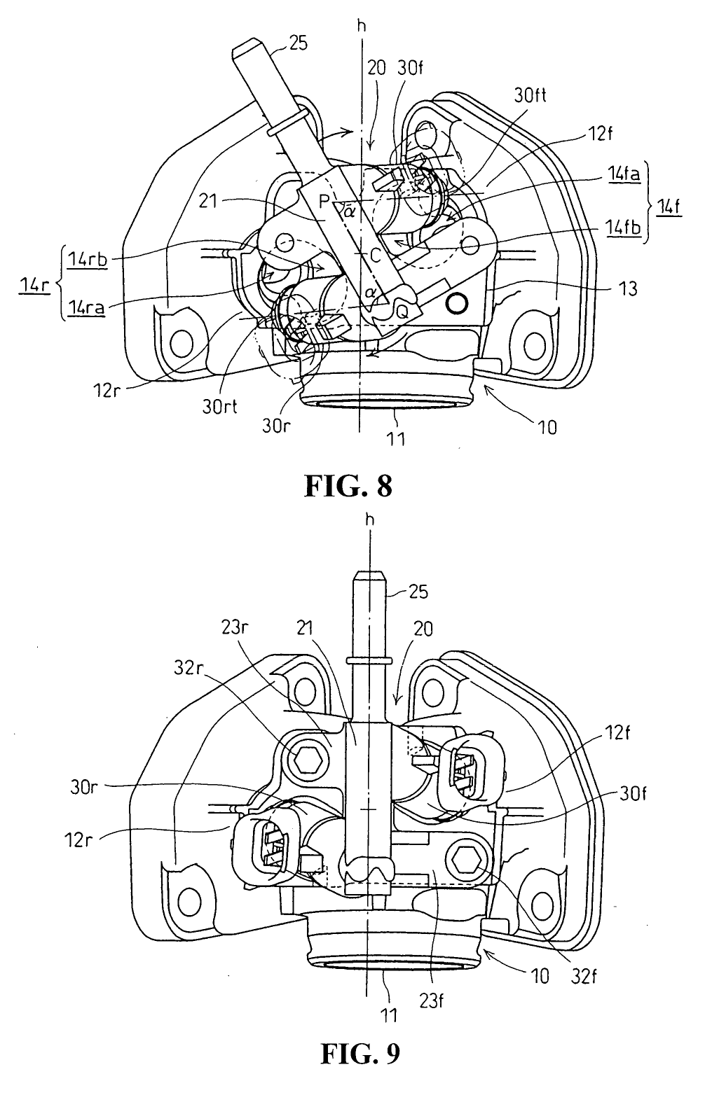

The fuel supply device 20 in the state in which the front injector 30f and the rear injector 30r are mounted to the fuel supply pipe 21 is arranged over the injector mounting base 13 of the intake manifold 10 as shown in FIG. 8.

In other words, the center point C of the segment PQ of the fuel supply pipe 21 is overlapped with the center point of the segment connecting the center of the opening of the distal end surface of the fitting hole 14fa of the front mounting hole 14f and the center of the opening surface of the distal end of the fitting hole 14ra of the rear mounting hole 14r on the injector mounting base 13 in top view. As shown in the top view in FIG. 8, the distal end portion 30ft of the front injector 30f is brought into proximity or contact with the tapered surface of the guide hole 14fb of the front mounting hole 14f and, simultaneously, the distal end portion 30rt of the rear injector 30r is brought into proximity or contact with the tapered surface of the guide hole 14rb of the rear mounting hole 14r.

At this time, as shown in FIG. 8, the fuel supply pipe 21 is in a posture rotated by a certain angle counterclockwise about the center point C with respect to a lateral horizontal line h which passes through the center point C in top view.

In FIG. 8, the couplers 31f, 31r projecting from the front injector 30f and the rear injector 30r are omitted for making the distal end portions 30ft, 30rt easily visible.

When the fuel supply device 20 is rotated clockwise and moved downwardly simultaneously from this state, the distal end portion 30ft which moves ahead of the rotation of the front injector 30f enters the guide hole 14fb of the front mounting hole 14f along the tapered surface thereof while following a helical track, then reaches the fitting hole 14fa and is fitted thereto and, simultaneously, the distal end portion 30rt which moves ahead of the rotation of the rear injector 30r enters the guide hole 14rb of the rear mounting hole 14r along the tapered surface thereof while following a helical track, then reaches the fitting hole 14ra and is fitted thereto, so that the front injector 30f and the rear injector 30r are simultaneously fitted to the front mounting hole 14f of the front air-intake pipe 12f and the rear mounting hole 14r of the rear air-intake pipe 12r respectively.

In this state, the direction in which the fuel supply pipe 21 is oriented corresponds to the lateral horizontal line h (see FIG. 9), and the lower surfaces of the mounting brackets 23f, 23r come into abutment with the mounting surface 13a of the injector mounting base 13 of the intake manifold 10, and the mounting holes 24f, 24r of the mounting brackets 23f, 23r correspond to the screw holes 16f, 16r of the injector mounting base 13, respectively.

Bolts 32f, 32r are inserted respectively to the mounting holes 24f, 24r of the mounting brackets 23f, 23r of the fuel supply device 20, are screwed into the screw holes 16f, 16r of the injector mounting base 13, and are tightened, so that the fuel supply device 20 is mounted to the injector mounting base 13 of the intake manifold 10, as shown in FIG. 9.

According to the fuel supply device 20, since the front injector 30f and the rear injector 30r are mounted to the fuel supply pipe 21 as described above, the fuel supply device 20, a pair of the injectors 30f, 30r can be mounted to the respective mounting holes 14f, 14r of the front and rear air-intake pipes 12f, 12r simultaneously, so that the number of components is small, the assembly work is easy, and superior assembleability is achieved.

When the front injector 30f and the rear injector 30r are driven at a predetermined timing in a state in which the fuel pipe is connected to the connecting pipe 25 projecting to the left from the fuel supply pipe 21 and fuel is pumped to the fuel supply pipe 21, the fuel is injected and mixed with intake air from the air cleaner 45 which is adjusted in the throttle body 40, and distributed to the front air-intake pipe 12f and the rear air-intake pipe 12r. The fuel-air mixture is supplied to the respective combustion chambers in the front bank cylinder 3f and the rear bank cylinder 3r at a predetermined timing (see an arrow in FIG. 3), which is provided for explosion in the front and rear combustion chambers in the internal combustion engine E.

The guide holes 14fb, 14rb of the front mounting hole 14f and the rear mounting hole 14r, which are spread upwardly into a distorted funnel shape, have wide spread openings respectively at the upper ends thereof which are wider than the front injector 30f and the rear injector 30r. Thus, gaps are formed even though the front injector 30f and the rear injector 30r are mounted respectively. Therefore, water drops or the like may be trapped therein. However, since the respective tapered surfaces of the guide holes 14fb, 14rb are formed with the water drain holes 15f, 15r for draining the trapped water, so that accumulation of water is avoided.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An injector mounting structure for a V-type internal combustion engine in which an intake manifold is arranged in a V-bank formed between cylinders arranged on the respective sides so as to be inclined to form a V-shape for sucking air to the respective cylinders, comprising:
a fuel supply pipe disposed in the V-bank and being oriented in parallel to a crankshaft and extending linearly; and
a pair of injectors branched from two branch portions spaced apart from each other in the direction of an axial line of the fuel supply pipe into an inverted V-shape in a side view from a direction of the axial line of the fuel supply pipe and extending in parallel to each other and obliquely at an acute angle with respect to a segment connecting the two branch portions in top view;
wherein the injectors are mounted by fitting respective distal end portions of the pair of injectors respectively to mounting holes formed on air-intake pipes on the respective sides of the intake manifold.

2. The injector mounting structure for a V-type internal combustion engine according to claim 1, wherein the mounting holes formed on the air-intake pipes on the respective sides are formed with water drain holes respectively.

3. The injector mounting structure for a V-type internal combustion engine according to claim 1, wherein said air-intake pipes includes a front air-intake port upstream opening end of an air-intake port of the cylinders in communication with a combustion chamber of a front bank cylinder.

4. The injector mounting structure for a V-type internal combustion engine according to claim 3, wherein a front exhaust port downstream opening end of an exhaust port communicates with the front bank cylinder.

5. The injector mounting structure for a V-type internal combustion engine according to claim 1, wherein said air-intake pipes includes a rear air-intake port upstream opening end of an air-intake port of the cylinders in communication with a combustion chamber of a rear bank cylinder.

6. The injector mounting structure for a V-type internal combustion engine according to claim 5, wherein a rear exhaust port downstream opening end of an exhaust port communicates with the rear bank cylinder.

7. The injector mounting structure for a V-type internal combustion engine according to claim 3, wherein the intake manifold is connected to the front air-intake port upstream opening end and projects into the V-bank.

8. The injector mounting structure for a V-type internal combustion engine according to claim 5, wherein the intake manifold is connected to the rear air-intake port upstream opening end and projects into the V-bank.

9. The injector mounting structure for a V-type internal combustion engine according to claim 1, wherein a front injector and a rear injector are arranged symmetric with respect to a center point with respect to a portion of the fuel supply pipe.

10. The injector mounting structure for a V-type internal combustion engine according to claim 1, wherein a front injector and a rear injector extend from the fuel supply pipe in an inverted V-shape.

11. An injector mounting structure for use with a V-type internal combustion engine comprising:
an air intake manifold arranged in a V-bank formed between cylinders;
a fuel supply pipe disposed in the V-bank and being oriented in parallel to a crankshaft and extending linearly; and
a pair of injectors branched from the fuel supply pipe and being spaced apart from each other in a direction of an axial line of the fuel supply pipe into an inverted V-shape in a side view from the direction of the axial line of the fuel supply pipe and extending in parallel to each other and obliquely at an acute angle with respect to a segment connecting the two branch portions in top view;
said injectors being mounted by fitting respective distal end portions of the pair of injectors respectively to mounting holes formed on air-intake pipes on the respective sides of the intake manifold.

12. The injector mounting structure for use with a V-type internal combustion engine according to claim 11, wherein the mounting holes formed on the air-intake pipes on the respective sides are formed with water drain holes respectively.

13. The injector mounting structure for use with a V-type internal combustion engine according to claim 11, wherein said air-intake pipes includes a front air-intake port upstream opening end of an air-intake port of the cylinders in communication with a combustion chamber of a front bank cylinder.

14. The injector mounting structure for use with a V-type internal combustion engine according to claim 13, wherein a front exhaust port downstream opening end of an exhaust port communicates with the front bank cylinder.

15. The injector mounting structure for use with a V-type internal combustion engine according to claim 11, wherein said air-intake pipes includes a rear air-intake port upstream opening end of an air-intake port of the cylinders in communication with a combustion chamber of a rear bank cylinder.

16. The injector mounting structure for use with a V-type internal combustion engine according to claim 15, wherein a rear exhaust port downstream opening end of an exhaust port communicates with the rear bank cylinder.

17. The injector mounting structure for use with a V-type internal combustion engine according to claim 13, wherein the intake manifold is connected to the front air-intake port upstream opening end and projects into the V-bank.

18. The injector mounting structure for use with a V-type internal combustion engine according to claim 15, wherein the intake manifold is connected to the rear air-intake port upstream opening end and projects into the V-bank.

19. The injector mounting structure for use with a V-type internal combustion engine according to claim 11, wherein a front injector and a rear injector are arranged symmetric with respect to a center point with respect to a portion of the fuel supply pipe.

20. The injector mounting structure for use with a V-type internal combustion engine according to claim 11, wherein a front injector and a rear injector extend from the fuel supply pipe in an inverted V-shape.
